(19) United States
(12) Patent Application Publication
(10) Pub. No.: US 2024/0013223 A1
(43) Pub. Date: Jan. 11, 2024

(54) COMPUTERIZED-METHOD FOR SYNTHETIC FRAUD GENERATION BASED ON TABULAR DATA OF FINANCIAL TRANSACTIONS

(71) Applicant: Actimize LTD., Ra'anana (IL)

(72) Inventors: Danny BUTVINIK, Haifa (IL); Kiran Kumar BATHULA, Mandamarri (IN)

(21) Appl. No.: 17/861,216

(22) Filed: Jul. 10, 2022

(51) Int. Cl. G06Q 20/40; G06F 16/215; G06F 16/22

(52) U.S. Cl. CPC G06Q 20/4016; G06F 16/215; G06F 16/2282

(57) ABSTRACT

A computerized-method for generating high-quality synthetic fraud-data based on tabular-data of financial transaction. The computerized-method includes: (i) receiving tabular-data of financial transactions; (ii) operating a fixing-module to handle missing values and yield cleaned tabular-data; (iii) forwarding the cleaned tabular-data to a deep-learning based synthetic data generation module to generate synthetic fraud-data; (iv) combining fraud transaction and the generated synthetic fraud-data to a training dataset and sending it to a ML model to differentiate between original fraud transactions and synthetic fraud transactions; (v) evaluating performance of the ML model by checking the ML model predictions of a preconfigured number of fraud transactions; (vi) aggregating misclassified data to be stored in a high-quality synthetic fraud database; (vii) generating a balanced training-dataset comprised of a preconfigured percent of synthetic fraud transactions and nonfraud transactions; and (viii) providing the generated balanced training-dataset to a fraud-detection ML model for training thereof.

### TECHNICAL FIELD

The present disclosure relates to the field of machine learning, deep learning and fraud detection.

### BACKGROUND

Fraud detection is a well-known example of Machine learning (ML) implementation in the real world. Supervised learning paradigm, also known as supervised ML, is a subcategory of machine learning and Artificial Intelligence (AI) in which ML algorithms use labeled historical data, e.g., fraud and nonfraud, as input to predict new output values. Which means, it uses labeled datasets to train algorithms to classify data or predict outcomes accurately.

A financial transaction is an agreement, or communication, between a buyer and a seller to exchange goods, services, or assets for payment. Any transaction involves a change in the status of the finances of two or more businesses or individuals. Examples of financial transactions include cash receipts, deposit corrections, requisitions, purchase orders, invoices, travel expense reports, PCard charges, and journal entries. A fraudulent transaction is an unauthorized use of an individual's accounts or payment information which may result in the victim's loss of funds, personal property, or personal information.

Financial institutions (FI)s are obligated to take steps to prevent fraud, as well as having the ability to identify the difference between fraudulent and legitimate transactions. ML models for fraud detection, identify fraudulent transactions among legitimate transactions based on the training on historical financial data, where transactions are binarily labeled based as fraud or nonfraud, i.e., legit.

Commonly, there is a class imbalance between fraud and nonfraud transactions in the training datasets provided to the ML algorithms which decreases the precision and accuracy of the ML algorithms when the ML algorithms run on new real time data, e.g., in production environment of a Financial Institute. The effect of the issue of class imbalance which is determined as 5% and above is worsen in cases of extreme imbalance in the training dataset, such as 0.01% or even 1 fraud transaction in a total of 10,000 transactions.

Therefore, in financial crime domain (FinCrime) the ability to generate synthetic fraud data, e.g., fraudulent transactions, is important and might play a vital role in the generalization and prediction power of ML models for fraud detection and fraud prevention.

However, synthetic fraud generation is an issue with far reaching consequences in the financial crime domain models for the following reasons. First, financial crime domain (FinCrime) does not have well defined metrics in the financial data. Second, characteristics of financial data may cause difficulties to oversampling fraudulent transactions due to being high-dimensional and having sparse data. Third, the structure of the financial data is tabular and often includes empty values in one or more cells in each column.

A neural network is a series of algorithms within deep learning paradigm that endeavors to recognize underlying relationships in a set of data through a process that mimics the way the human brain operates. In this sense, neural networks refer to systems of neurons, either organic or artificial in nature.

Deep learning algorithms are a type of Machine Learning (ML) and Artificial Intelligence (AI) that initiates the way humans gain certain types of knowledge and it establishes an important element of data science, which includes statistics and predictive modeling. It is based on neural networks and uses multiple layers to progressively extract higher-level features from the raw input. For example, in image processing, lower layers may identify edges, while higher layers may identify the concepts which are of human interest, such as digits or letters or faces.

While deep learning techniques for synthetic data generation excel in structured data as encountered in vision and natural language processing, it fails to meet its expectations on tabular data. Most of the use cases of synthetic data generation are applied on images or other type of data structures other than tabular data. However, when a powerful synthetic data generation technique is applied on tabular data of financial transactions, the quality of the generated synthetic fraud is low. Low quality of synthetic fraud practically means that it may not be a good fit to be added to a training dataset of a ML model to overcome extreme imbalance issues, because it is not similar to original financial transactions.

Accordingly, there is a need for a technical solution for generating high-quality synthetic financial fraud considering all of the above-mentioned obstacles which are characteristics of financial data. Financial data lacks well-defined metrics, has high-dimensionality and sparsity and a tabular structure. Furthermore, there is a need to enable measurement of the level of quality of synthetic fraud and filter it accordingly.

Moreover, there is a need for a computerized-method for: (1) tackling extreme class imbalance and building well-generalized ML models through the process of training them on representative dataset; and (2) transferring synthetic fraud from client to client without a concern as to data privacy issues, because generated synthetic fraud is both synthetic and encrypted.

### SUMMARY

There is thus provided, in accordance with some embodiments of the present disclosure, a computerized-method for generating high-quality synthetic fraud data based on tabular data of financial transaction.

In accordance with some embodiments of the present disclosure, the computerized-method includes: (i) receiving tabular data of financial transactions having one or more columns; (ii) operating a fixing module to handle missing values in the received tabular data of financial transactions and yield cleaned tabular data; (iii) forwarding the cleaned tabular data to a deep learning based synthetic data generation module to generate synthetic fraud data; (iv) combining fraud transactions from the yielded cleaned tabular data and the generated synthetic fraud data to a training dataset and sending the training dataset to a machine learning model to differentiate between original fraud transactions and synthetic fraud transactions; (v) evaluating performance of the machine learning model by checking the machine learning model predictions of a preconfigured number of fraud transactions; (vi) when there is above a preconfigured threshold number of wrong predictions, aggregating misclassified data to be stored in a high-quality synthetic fraud database; (vii) generating a balanced training dataset that is comprised of a preconfigured percent of synthetic fraud transactions from the high-quality synthetic fraud database and nonfraud transactions from the received tabular data of financial transactions; and (viii) providing the generated balanced training dataset to a fraud-detection machine learning model for training thereof, thereby increasing precision and accuracy of fraud predictions of the fraud-detection machine learning model when the fraud-detection machine learning model is processing real time data.

Furthermore, in accordance with some embodiments of the present disclosure, the fixing-module may include: (i) calculating a median statistic for each column of the one or more columns that is having a numeric value to fill each empty cell in the column with the calculated median statistics; and (ii) calculating a mode statistic for each column of the one or more columns that is having a categorical value to fill each empty cell in the column with the calculated mode statistic.

Furthermore, in accordance with some embodiments of the present disclosure, the deep learning based synthetic data generation module may be Conditional Generative Adversarial Networks (CTGAN).

Furthermore, in accordance with some embodiments of the present disclosure, the tabular data of financial transactions may have extreme imbalance between fraud and nonfraud transactions, and the extreme imbalance is when fraud transactions are below 0.01% of total financial transactions.

Furthermore, in accordance with some embodiments of the present disclosure, misclassified data is an indication of high-quality results. High-quality synthetic fraud data is data that is similar to original fraud to a point that a trained ML model may classify a synthetic fraud transaction as an original one.

Furthermore, in accordance with some embodiments of the present disclosure, when there is above a preconfigured threshold number of wrong predictions the synthetic fraud transactions are misclassified as original fraud transactions.

Furthermore, in accordance with some embodiments of the present disclosure, misclassified data includes synthetic fraud transactions which were classified as original fraud transactions by the machine learning model.

Furthermore, in accordance with some embodiments of the present disclosure, the median statistic may be calculated based on formula I:

$$median ( X ) = \{ \begin{matrix}X [ \frac{n}{2} ] if n is even \\ X [ \frac{n - 1}{2} ] + X [ \frac{n + 1}{2} ] if n is odd\end{matrix}$$

whereby:
n is number of values in a column in the tabular data of financial transactions, and
X is an ordered list of n values in the column.

Furthermore, in accordance with some embodiments of the present disclosure, the mode statistic may be calculated by counting occurrence of each category and determining the mode statistic as a category having highest count of occurrences.

Furthermore, in accordance with some embodiments of the present disclosure, in a multitenant environment, the received tabular data of financial transactions is of a first tenant and the high-quality synthetic fraud database is used for generating a balanced training dataset to train a fraud-detection machine learning model of a second tenant.

Furthermore, in accordance with some embodiments of the present disclosure, in a multitenant environment, for each one or more tenants, generating high-quality synthetic fraud data based on a received tabular data of financial transaction to be stored in the high-quality synthetic fraud database, wherein the high-quality synthetic fraud data is used to generate the balanced training dataset.

Furthermore, in accordance with some embodiments of the present disclosure, the increasing precision and accuracy of fraud predictions of the fraud-detection machine learning model may be measured by at least one of: (i) Receiver Characteristic Operator (ROC) Area under Curve (AUC); (ii) precision; (iii) recall; (iv) F1 score; and (v) another criterion.

### BRIEF DESCRIPTION OF THE DRAWINGS

In order for the present disclosure, to be better understood and for its practical applications to be appreciated, the following Figures are provided and referenced hereafter. It should be noted that the Figures are given as examples only and in no way limit the scope of the disclosure. Like components are denoted by like reference numerals.

FIG. 1 illustrates existing class imbalance methods, techniques and approaches;

FIG. 2 schematically illustrates a high-level diagram of a computerized-system for high quality synthetic frauds generation on high-dimensional sparse financial tabular data, in accordance with some embodiments of the present disclosure;

FIGS. 3A-3B are a schematic flowchart of a computerized-method for generating high-quality synthetic fraud data based on tabular data of financial transaction, in accordance with some embodiments of the present disclosure;

FIG. 4 is a high-level diagram of machine learning flow development where there is an extreme class imbalance, in accordance with some embodiments of the present disclosure;

FIG. 5 illustrates a process of generating synthetic fraud, in accordance with some embodiments of the present disclosure;

FIG. 6 illustrates a bank of synthetic fraud that can be used to augment a training dataset and resolve the problem of extreme class imbalance within each one of the tenants, in accordance with some embodiments of the present disclosure;

FIGS. 7A-7B is a table showing a performance of a machine learning model by Area Under the Receiver Characteristic Operator (ROC) Curve (AUC) on an unseen test dataset, for a given number of known or real fraud transactions and synthetic fraud transactions, in accordance with some embodiments of the present disclosure;

FIGS. 8A-8C show results for a fraud-detection machine learning model that has 5 original fraud transactions and 8745 synthetic fraud transactions, in accordance with some embodiments of the present disclosure; and

FIG. 9 is a high-level process flow diagram of a system, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Machine Learning (ML) models for fraud detection identify fraudulent transactions among legitimate i.e., nonfraud transactions based on training dataset of historical financial data, where transactions are binarily labeled as fraud or nonfraud. The ML models identify the fraudulent transactions to prevent from fraud being conducted via the financial transactions.

In real world data, there are very few fraudulent transactions than legitimate transactions, which is referred to as class imbalance. In class imbalance there is an inequality between the minority class, i.e., fraudulent transactions, and the majority class, i.e., legitimate transactions.

Class imbalance impacts the quality of trained ML models because if a model has trained on a dataset that has class imbalance, then it might affect the ML model performance in production environment which means that there might be a misclassification error of one or more financial transactions. For example, some legitimate transactions might be identified as fraud and vice versa. When a ML model predicts that a particular transaction is fraud when in fact it is legitimate then it is named False Positive (FP).

Large number of FPs might significantly exhaust the FIs resources, since each suspected transaction, e.g., a transaction that has been identified as fraudulent by the ML model, must be investigated and each investigation is of high cost. Consequently, if the ML model produces many FPs, the FI might spend a lot of money on investigations, while real fraud is not being detected. A significant part of money loss may come from undetected fraud, which is false negative.

There are existing ML methods to tackle the problem of class imbalance, however, existing ML methods do not provide an appropriate solution that suits financial data characteristics, which include lack of well-defined metrics, has high-dimensionality and sparsity and a tabular structure.

Moreover, all of the most advanced ML methods for oversampling, e.g., enrichment or augmenting fraudulent transactions are not efficient in cases where class imbalance is below 5%. That means, a case where for every 100 transactions there are less than 5 fraudulent transactions, and the rest are legitimate transactions, or when there is 1 fraudulent transaction in a total of 10,000 transactions.

Moreover, all existing ML methods for fraud data augmentation are based on defined metrics within the data. Without well-defined metrics these ML methods are incapable to produce high quality synthetic fraud, e.g., accurate predictions. Therefore, all of existing ML methods and approaches are not efficient for resolving the problem that class imbalance or extreme class imbalance creates when provided as a training dataset to a ML model.

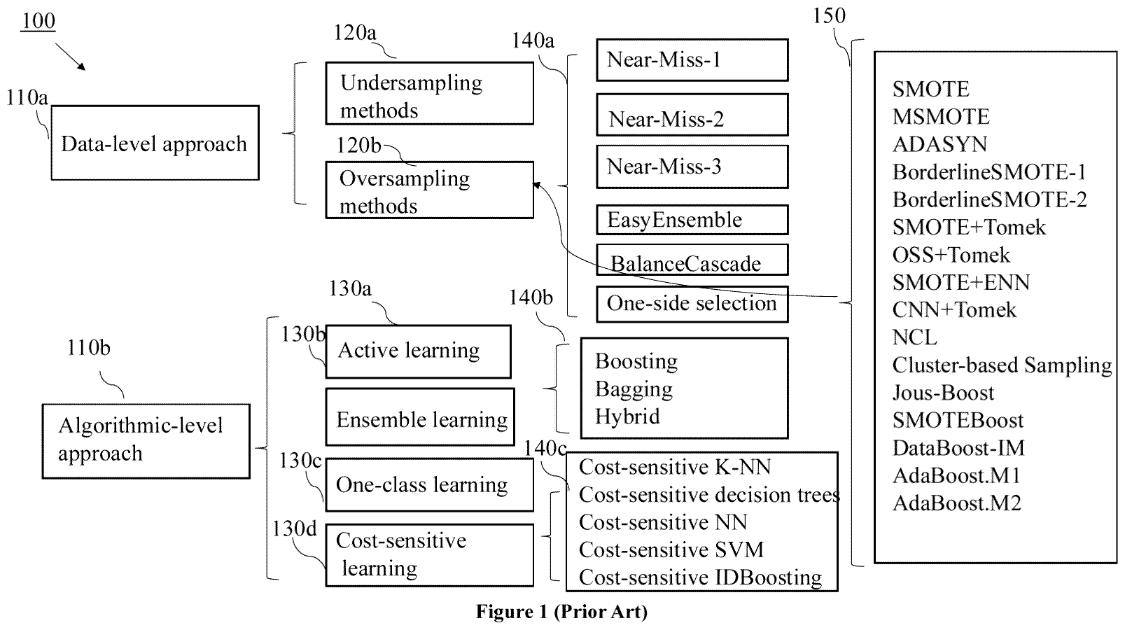

FIG. 1 illustrates existing class imbalance methods 100, techniques and approaches. Currently there are two approaches within existing solutions to handle class imbalance issue in training datasets. Data-level approach 110a and Algorithmic-level approach 110b. In data-level approach 110a, there are oversampling methods 120b that handle enriching data, i.e., fraud. Oversampling methods may be for example, the list of methods in element 150. Synthetic Minority Oversampling Technique (SMOTE), MSMOTE, ADASYN, BorderlineSMOTE-1, BorderlineSMOTE-2, SMOTE+Tomek, One Sided Selection (OSS)+Tomek, SMOTE+Edited Nearest Neighbor Rule (ENN), Condensed Nearest Neighbor Rule (CNN)+Tomek, Neighborhood Cleaning Rule (NCL), Cluster-based Sampling, Jous-Boost, SMOTEBoost, DataBoost-IM, AdaBoost.M1, AdaBoost.M2.

Undersampling methods 120a are not relevant in case of fraud detection, since there is a need to augment a fraud space, i.e., enrich fraudulent transactions. The algorithms listed in elements 130a-130d, and 140a-c are different families of paradigms within machine learning for handling class imbalance problems and they perform both undersampling and oversampling procedures.

In current practice of fraud detection and prevention, class imbalance in a dataset might be approximately 0.05%-1%, and therefore it is called extreme class imbalance. In such cases all existing methods for oversampling minority class, e.g., fraudulent transactions, become inefficient even more. Therefore, there is a need for a technical solution for enriching or augmenting or enlarging fraud space or fraudulent transactions space significantly.

Currently, there might be ways to solve the problem of extreme imbalance efficiently. One way is to utilize the fact that current solutions work with many clients, e.g., banks or FIs or tenants, to take a fraudulent transaction from one tenant and then add it in another tenant. For example, in a multitenant environment, when building a ML model for tenant ‘A’ that has extreme class imbalance, taking into account data from tenants ‘B’ and ‘C’. Meaning, transferring fraudulent transactions from tenant ‘B’ and tenant ‘C’ to tenant ‘A’ and by that alleviating extreme class imbalance in ‘A’.

However, this way imposes a problem due to data privacy. Data may not be transferred from tenant to tenant if this data is not protected, e.g., encrypted, and agreed upon the tenants. Very often, tenants do not agree to share their real data with other tenants even if the real data is encrypted.

Another way is to generate synthetic frauds or fraudulent transactions, based on existing minority class and by that augment the minority class, e.g., fraudulent transactions, i.e., fraud space augmentation or enrichment. Generated synthetic data is encrypted.

However, the ability to generate synthetic frauds is not a trivial task due to numerous reasons. First, FinCrime domain lacks well-defined metrics that are necessary to perform the synthetic generation. Since, financial transactions are high dimensional vectors with heterogenic data, and it is impossible to define a distance between transaction ‘A’ and transaction ‘B’ having the same parameters, such as payer name, amount, address, bank branch, transaction type, time, IP device payee, address and the like. This is unlike digital imaging, where there is well-defined metrics between the pixels since it is within Euclidian metrics space. Defined metrics is a critical condition for generating synthetic data.

Second, financial data is high-dimensional, i.e., a transaction might be a long vector of attributed and each attribute represents dimension. Financial data may be sparse data and there may be a lot of empty values, e.g., missing values within the financial transactions. This imposes a serious problem for any method of oversampling the data or enriching fraud space.

Third, the structure of financial data is tabular. Tabular data imposes significant difficulties and constraints for any of the oversampling techniques, including powerful deep learning tools, such as neural networks. For example, the of Neural Networks are not configured to handle tabular data structure and when it runs on tabular data, the performance is not meeting expectation. Another difficulty is that all mentioned techniques for undersampling and oversampling work if there is well-defined metrics, e.g., there is a defined metrics distance between one vector to another or one transaction to another. Since, there is no defined metrics in FinCrime, it imposes a problem for all of existing techniques and methods to work properly, precisely, robustly and provide accurate predictions.

On digital image augmenting or oversampling data, may be easily achieved by a wide spectrum of tools, when neural networks are most powerful. But applying neural networks on tabular data to enrich fraud space, doesn't provide meaningful results. Tabular data differs from digital image by many principal concepts and parameters which imposes constraints on synthetic generation of fraudulent transactions on financial tabular high dimensional sparse data.

Accordingly, there is a need for a technical solution to synthetically generate high-quality fraudulent transactions and overcome above mentioned constraints.

The needed technical solution that may solve the issues that arise when having extreme class imbalance by providing the ability to generate high quality synthetic fraud may directly boost the performance of the ML models when running on new real data. The needed technical solution should make the ML models become much more precise and accurate. Furthermore, there is a need for a technical solution that may obtain a ‘bank’ of high-quality synthetic fraud that will serve all the tenants to build representative training dataset for training the ML model. This ML model may be trained on original fraud individually, and on a ‘bank’ or pool of synthetic fraud based on all tenants. High-quality synthetic fraud data is data that is similar to original fraud to a point that a trained ML model may misclassify the high-quality synthetic fraud transaction as an original one.

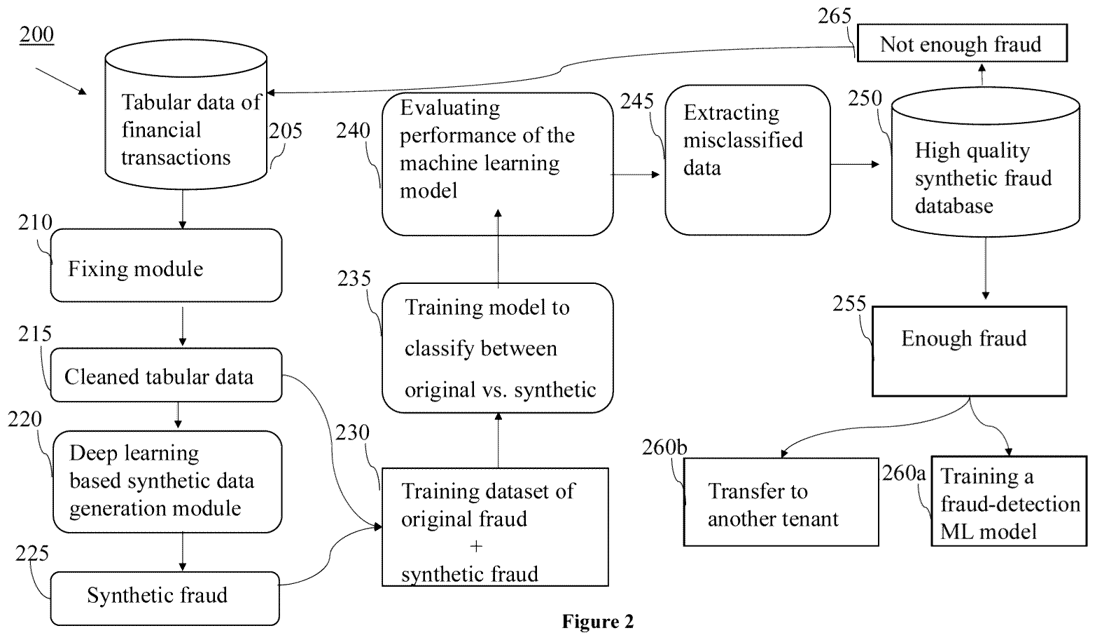

FIG. 2 schematically illustrates a high-level diagram of a computerized-system 200 for high quality synthetic frauds generation on high-dimensional sparse financial tabular data, in accordance with some embodiments of the present disclosure.

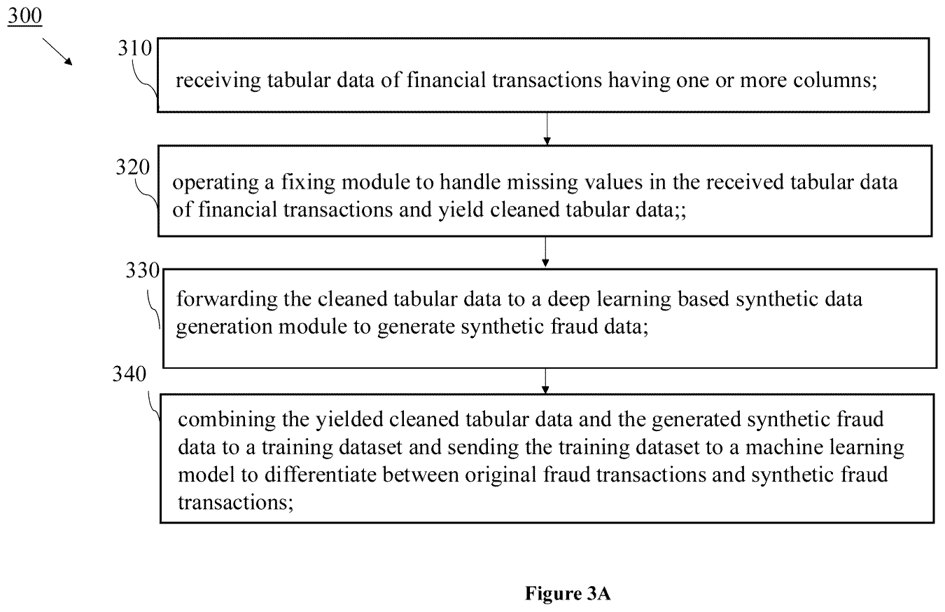

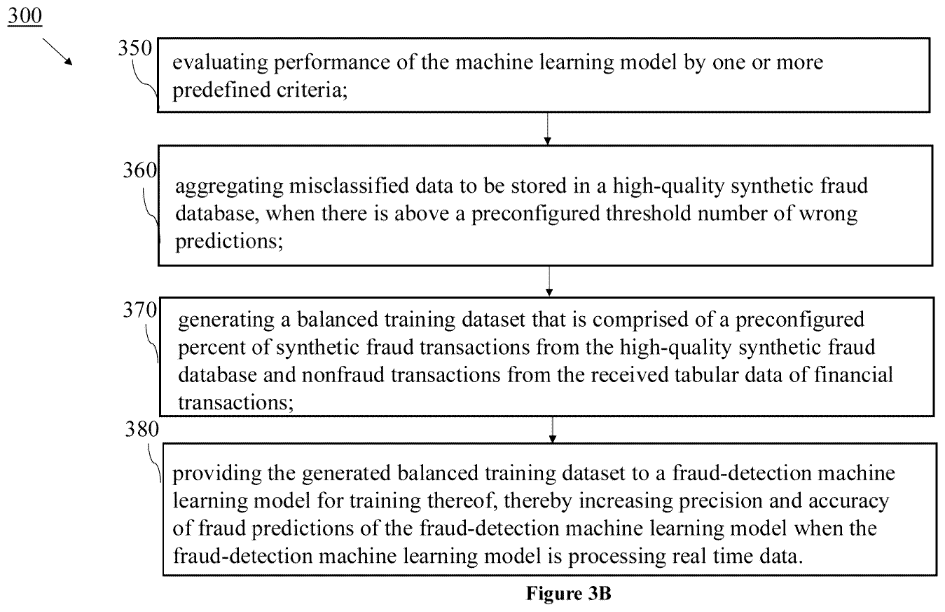

According to some embodiments of the present disclosure, a system, such as computerized-system 200 may include a database of tabular data of financial transactions 205 and may implement a computerized-method, such as computerized-method for generating high-quality synthetic fraud data based on tabular data of financial transaction 300 in FIGS. 3A-3B.

Tabular financial data consists of rows, where each row represents a transaction which is a vector of attributes or features. Each transaction depicts personal information of a person who transferred money, sum of the money that is being transferred, and personal information of the person who receives the money, name of the bank, type of transaction etc. There are four main types of transactions: sales, purchases, receipts, and payments. Commonly, in each segment of a tabular financial data, there is an empty value of an attribute in one of the rows, which is an obstacle for generating synthetic frauds of high quality.

According to some embodiments of the present disclosure, tabular data of financial transactions having one or more columns may be retrieved and forwarded to a module, such as fixing module 210 to handle missing values in the retrieved tabular data. The fixing module 210 may yield cleaned tabular data 215, which includes original fraud and nonfraud transactions.

According to some embodiments of the present disclosure, the tabular data of financial transactions may have extreme imbalance between fraud and nonfraud transactions, and the extreme imbalance is when fraud transactions are below 0.01% of total financial transactions.

According to some embodiments of the present disclosure, the fixing-module 210 may include: (i) calculating a median statistic for each column of the one or more columns that is having a numeric value to fill each empty cell in the column with the calculated median statistics; and (ii) calculating a mode statistic for each column of the one or more columns that is having a categorical value to fill each empty cell in the column with the calculated mode statistic.

According to some embodiments of the present disclosure, the median statistic may be calculated based on formula I:

$$median ( X ) = \{ \begin{matrix}X [ \frac{n}{2} ] if n is even \\ X [ \frac{n - 1}{2} ] + X [ \frac{n + 1}{2} ] if n is odd\end{matrix}$$

whereby:
n is number of values in a column in the tabular data of financial transactions, and
X is an ordered list of n values in the column.

According to some embodiments of the present disclosure, the mode statistic may be calculated by counting occurrence of each category and determining the mode statistic as a category having highest count of occurrences. For example, when there are four transaction types, ‘A’, ‘B’, ‘C’ and ‘D’ and the frequency of type ‘A’ is ‘3’, the frequency of type ‘B’ is ‘7’, the frequency of type ‘C’ is ‘4’, and the frequency of type ‘D’ is ‘5’, the mode statistic for each empty cell in the column may be type ‘B’.

According to some embodiments of the present disclosure, fraud transactions from the cleaned tabular data 215 may be forwarded to a module, such as deep learning based synthetic data generation module 220 to yield synthetic fraud data 225. The yielded synthetic fraud data 225 may be encrypted and of high quality.

According to some embodiments of the present disclosure, the deep learning based synthetic data generation module 220 may be implemented by Conditional Generative Adversarial Networks (CTGAN) which is a type of neural network. CTGAN is a collection of deep learning based synthetic data generators for single table data, which are able to learn from real data and generate synthetic clones with high fidelity, i.e., high quality.

According to some embodiments of the present disclosure, despite the fact that CTGAN is a known tool that should work well on tabular data for generating synthetic frauds, yet it does not perform well and requires an improvement. The improvement is that cleaned tabular data 215 is provided to it instead of the retrieved tabular data of financial transactions having one or more columns.

According to some embodiments of the present disclosure, fraud transactions from the cleaned tabular data 215 may be combined with the yielded synthetic fraud data 225 to a training dataset 230 and sending the training dataset to a machine learning model. The machine learning model may be trained to classify between original fraud transactions and synthetic fraud transactions 235.

According to some embodiments of the present disclosure, evaluating performance of the machine learning model 240 by checking the machine learning model predictions of a preconfigured number of fraud transactions.

According to some embodiments of the present disclosure, when there is above a preconfigured threshold number of wrong predictions the synthetic fraud transactions are misclassified as original fraud transactions. Misclassified data includes synthetic fraud transactions which were classified as original fraud transactions. Furthermore, misclassified data is an indication of high-quality results of synthetic fraud data because it implies that the machine learning failed differentiating between original fraud transaction and synthetic fraud transaction.

According to some embodiments of the present disclosure, when there is above a preconfigured threshold number of wrong predictions, aggregating and extracting misclassified data 245 to be stored in a high-quality synthetic fraud database 250.

According to some embodiments of the present disclosure, after checking if there is enough synthetic fraud data 255 in the high quality synthetic fraud database 250, generating a balanced training dataset that is comprised of a preconfigured percent of synthetic fraud transactions from the high-quality synthetic fraud database and nonfraud transactions from the received tabular data of financial transactions and providing the generated balanced training dataset to a fraud-detection Machine Learning (ML) model for training thereof, i.e., training the fraud-detection ML model 160a. Thereby increasing precision and accuracy of fraud predictions of the fraud-detection ML model when the fraud-detection ML model is processing real time data, especially when the real time data is new.

According to some embodiments of the present disclosure, the increasing precision and accuracy of fraud predictions of the fraud-detection machine learning model is measured by at least one of: (i) Receiver Characteristic Operator (ROC) Area under Curve (AUC); (ii) precision; (iii) recall; (iv) F1 score; and (v) another criterion.

According to some embodiments of the present disclosure, in a multitenant environment, the received tabular data of financial transactions is of a first tenant and the data in the high-quality synthetic fraud database 250 may be used for generating a balanced training dataset to train a fraud-detection ML model of a second tenant, i.e., transfer to another tenant 260b.

According to some embodiments of the present disclosure, when not enough fraud transactions 265 have been generated, retrieving more tabular data of financial transactions, from the tabular data of financial transactions 205 and repeating the operations of computerized-method 300 in FIGS. 3A-3B.

According to some embodiments of the present disclosure, this allows to build a ‘bank’ of synthetic fraud transactions to serve several tenants, i.e., clients and to provide a balanced training dataset for machine learning models to detect fraud.

FIGS. 3A-2B a schematic flowchart of a computerized-method 300 for generating high-quality synthetic fraud data based on tabular data of financial transaction, in accordance with some embodiments of the present disclosure.

According to some embodiments of the present disclosure, operation 310 may comprise receiving tabular data of financial transactions having one or more columns. Each column has values of an attribute of the financial transaction. For example, payer name, amount, address, bank branch, transaction type, time, IP device payee, address and the like.

According to some embodiments of the present disclosure, operation 320 may comprise operating a fixing module to handle missing values in the received tabular data of financial transactions and yield cleaned tabular data. The fixing module may be a module such as fixing module 210, in FIG. 2.

According to some embodiments of the present disclosure, operation 330 may comprise forwarding the cleaned tabular data to a deep learning based synthetic data generation module to generate synthetic fraud data. The synthetic fraud data may be encrypted and of high-quality such as a machine learning model may misclassify a synthetic fraud transaction as original one.

According to some embodiments of the present disclosure, operation 340 may comprise combining fraud transactions from the yielded cleaned tabular data and the generated synthetic fraud data to a training dataset and sending the training dataset to a machine learning model to differentiate between original fraud transactions and synthetic fraud transactions.

According to some embodiments of the present disclosure, operation 350 may comprise evaluating performance of the machine learning model by one or more predefined criteria.

According to some embodiments of the present disclosure, operation 360 may comprise aggregating misclassified data to be stored in a high-quality synthetic fraud database, when there is above a preconfigured threshold number of wrong predictions.

According to some embodiments of the present disclosure, operation 370 may comprise generating a balanced training dataset that is comprised of a preconfigured percent of synthetic fraud transactions from the high-quality synthetic fraud database and nonfraud transactions from the received tabular data of financial transactions.

According to some embodiments of the present disclosure, operation 380 may comprise providing the generated balanced training dataset to a fraud-detection machine learning model for training thereof, thereby increasing precision and accuracy of fraud predictions of the fraud-detection machine learning model when the fraud-detection machine learning model is processing real time data. The real time processed data is real time financial transactions which has to be classified as fraud or nonfraud.

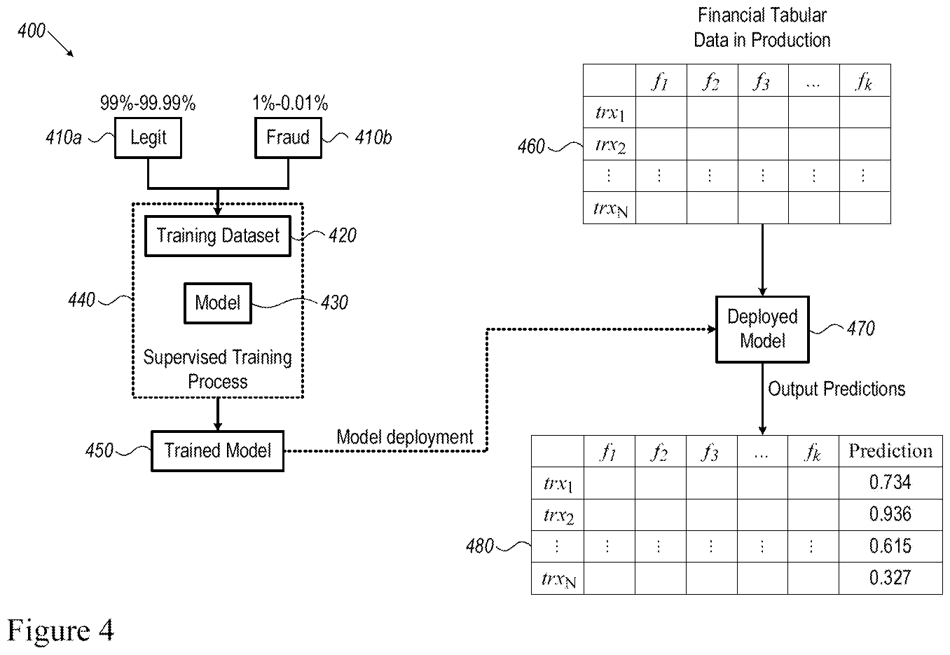

FIG. 4 is a high-level diagram of machine learning flow development 400 where there is an extreme class imbalance, in accordance with some embodiments of the present disclosure.

Skewed training dataset 420 that includes mainly legit transactions 410a and a very few fraudulent transactions 410b 1%-0.01% which may be provided to a fraud-detection machine learning model 430 for a supervised training process 440. Then, the trained model 450 may be deployed into production environment where it might predict incoming financial data 460 that its structure is in a tabular form.

The deployed model 470 makes a prediction for every transaction if it is fraud or nonfraud and provides a regression score between 0 and 100 which indicates the likelihood or probability for a transaction to be a fraud. For example, a score of 0.327 indicates a low probability that a particular transaction is fraud. However, a score of 0.936 indicates a very high probability that a particular transaction is fraud, as shown in element 480. These predictions 480 are being sent to a user for further investigation of transactions which have a high probability to be fraud.

According to some embodiments of the present disclosure, instead of fraudulent transactions 410b of 1%-0.01% which makes the training dataset 420 extremely imbalanced, high quality synthetic fraud transactions may be generated e.g., by deep learning based synthetic data generation module 220 in FIG. 2 in computerized-system 200 or by computerized-method 300 in FIGS. 3A-3B to be combined with yielded cleaned tabular data, such as cleaned tabular data 215 in FIG. 2 for a balanced training dataset.

According to some embodiments of the present disclosure, the number of synthetic fraud transactions in the balanced training dataset depends on the number of generated synthetic fraud transactions and also on the initial number of the original fraud transactions in the received tabular data of financial transactions. For example, when there is only one fraud transaction in the received tabular data of financial transactions then, it is expected to have a preconfigured percent of fraud transactions in the training dataset, above 8%. When the original fraud transactions in the tabular data of financial transactions is 5 transactions, then it is expected to have a preconfigured percent of fraud transactions in the training dataset, above 14%.

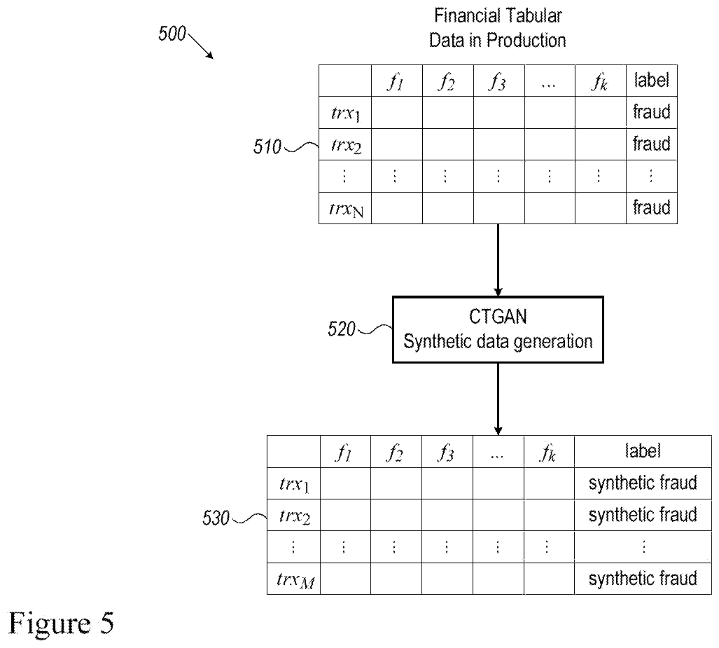

FIG. 5 illustrates a process of generating synthetic fraud 500, in accordance with some embodiments of the present disclosure.

According to some embodiments of the present disclosure, the number of generated synthetic fraud ‘M’ 530 is not necessarily always larger or smaller than number of original frauds ‘N’ 510. It depends on the preconfigured setting parameters of the deep learning based synthetic data generation module 220 in FIG. 2, such as CTGAN.

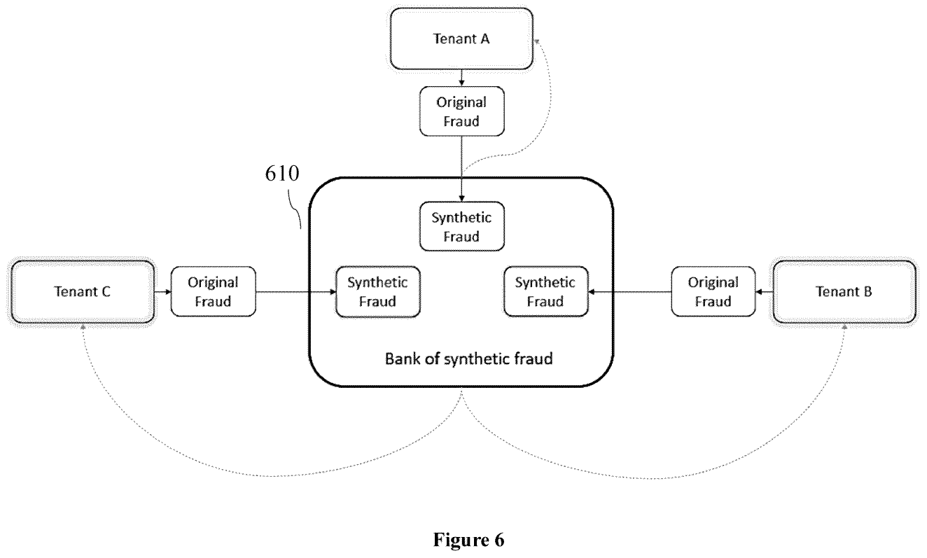

FIG. 6 illustrates a bank of synthetic fraud that can be used to augment a training dataset and resolve the problem of extreme class imbalance within each one of the tenants, in accordance with some embodiments of the present disclosure.

According to some embodiments of the present disclosure, in a multitenant environment, for each one or more tenants, e.g., tenants ‘A’, ‘B’ and ‘C’, generating high-quality synthetic fraud data based on a received tabular data of financial transaction to be stored in a bank of synthetic fraud 610 e.g., high-quality synthetic fraud database 250 in FIG. 2. The high-quality synthetic fraud data may be used to generate the balanced training dataset for separately training a fraud-detection machine learning model for each tenant.

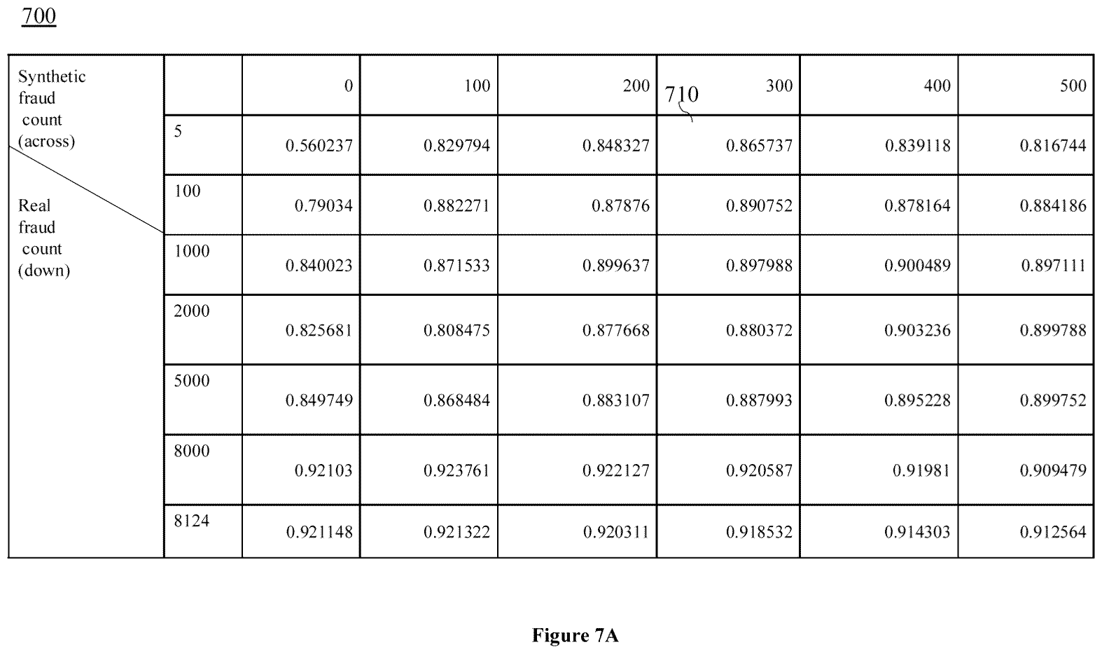

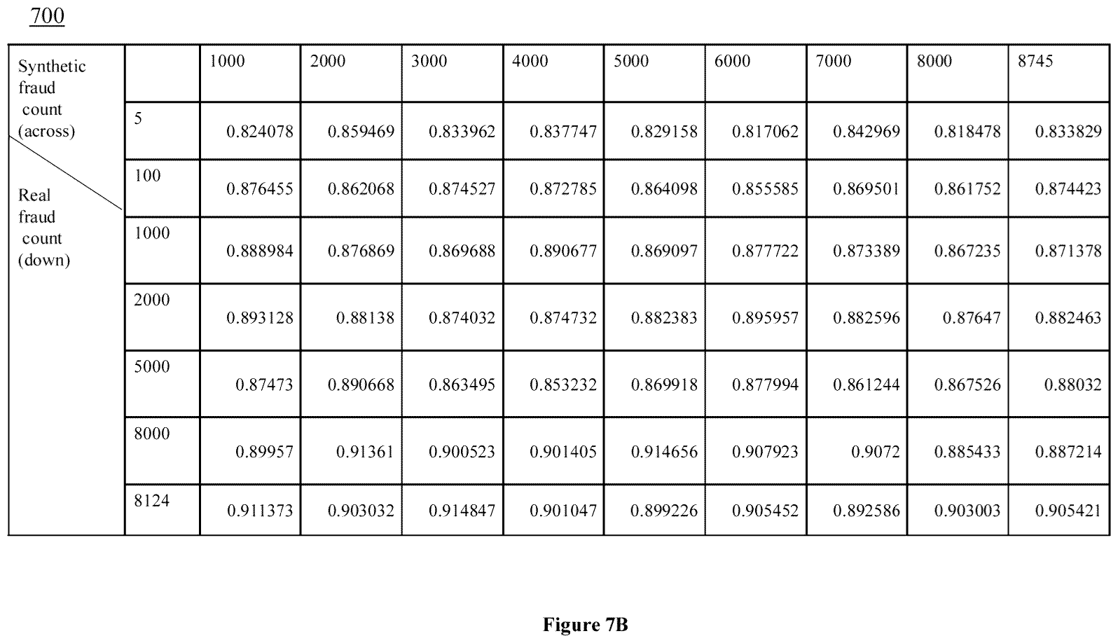

FIGS. 7A-7B is a table 700 showing a performance of a machine learning model by Area Under the Receiver Characteristic Operator (ROC) Curve (AUC) on an unseen test dataset, for a given number of known or real fraud transactions and synthetic fraud transactions, in accordance with some embodiments of the present disclosure.

To evaluate the quality of the synthetic data that has been generated, a fraud-detection machine learning model has been evaluated by ROC_AUC according to different levels of synthetic frauds. The fraud detection machine learning model has been trained on the same dataset but with additional transactions that are generated synthetically, e.g., by computerized-system 200 in FIG. 2 or computerized-method 300 in FIGS. 3A-3B. The comparison has been repeated with various numbers of known or real fraud transactions and synthetic fraud transactions. In each of the iterations, if the synthetic data generated is good, the second model have performed better in detecting fraud.

Each value in table 700 shows the performance of the machine learning models in terms of Receiver Characteristic Operator (ROC) Area under Curve (AUC) on an unseen test dataset. For given number of known/real fraud transactions and synthetic fraud transactions.

Each cell in table 700 represents ROC_AUC value per each run of the fraud-detection machine learning model.

According to some embodiments of the present disclosure, for example, in case of real fraud count of 5 and synthetic fraud count of 300 and optimum result 710 may be achieved.

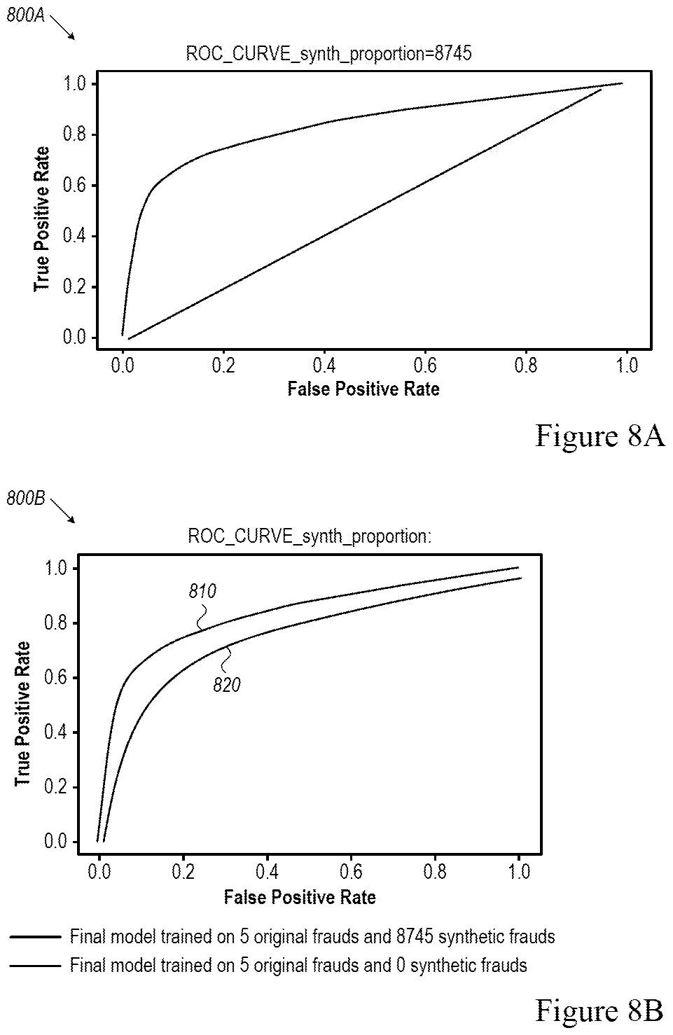

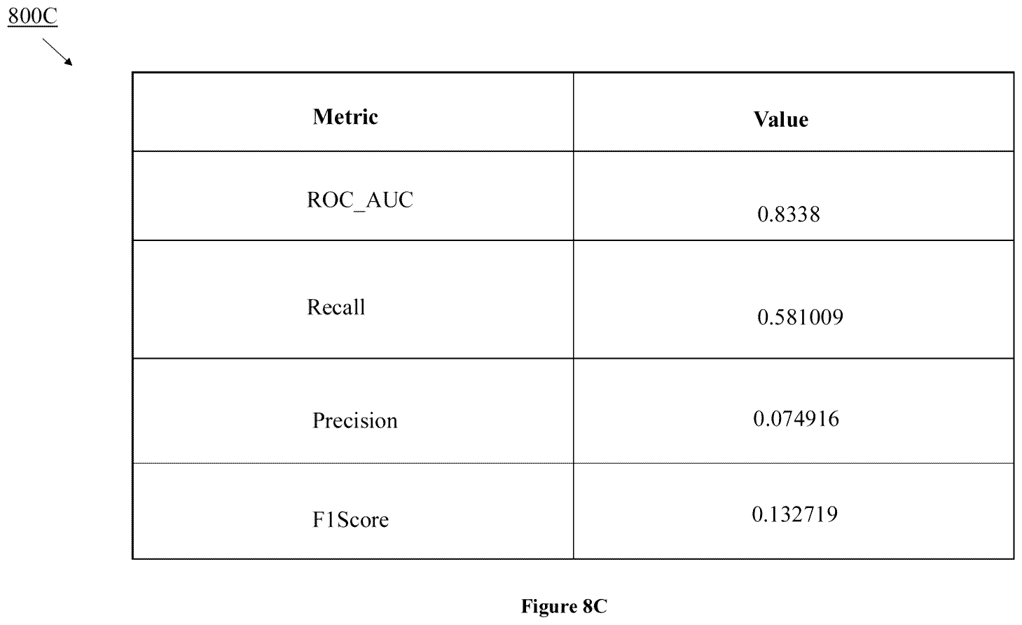

FIGS. 8A-8C show results for a machine learning fraud-detection model that has 5 original fraud transactions and 8745 synthetic fraud transactions, in accordance with some embodiments of the present disclosure.

According to some embodiments of the present disclosure, graph 800A shows an improvement in the performance of the fraud-detection machine learning model with an additional of synthetic fraud data as shown in FIG. 2 and the related paragraphs. The larger the area under the curve and the y=x line, the better the machine learning model performance.

According to some embodiments of the present disclosure, graph 800B shows results of a fraud-detection machine learning model on synthetic generated frauds with 5 original frauds and 8745 synthetic fraud transactions, as curve 810 and results of a fraud-detection machine learning model on only 5 original frauds and zero synthetic frauds as curve 820. The ROC_AUC of curve 820 of the second model is below the curve of the first model 810. Accordingly, it shows that the first model that its results are represented by curve 810 performs better than the second model that its results are represented by curve 820.

According to some embodiments of the present disclosure, table 800C shows results of Receiver Characteristic Operator (ROC) Area under Curve (AUC), recall, precision; recall, and F1 score criteria.

According to some embodiments of the present disclosure, ROC_AUC is a measurement that may be presented by a graph that is showing the performance of a classification model at all classification thresholds. AUC measures the entire two-dimensional area underneath the entire ROC curve. The larger the area under the curve the better performance of the fraud-detection machine learning model.

According to some embodiments of the present disclosure, recall is calculated as the ratio between the numbers of Positive samples correctly classified as Positive to the total number of Positive samples. The recall measures the fraud-detection machine learning model's ability to detect positive samples. The higher the recall, the more positive samples detected.

According to some embodiments of the present disclosure, precision is an indicator of a machine learning model's performance, the quality of a positive prediction made by the fraud-detection machine learning model. Precision refers to the number of true positives divided by the total number of positive predictions (i.e., the number of true positives plus the number of false positives).

According to some embodiments of the present disclosure, F1-score sums up the predictive performance of a model by combining two otherwise competing metrics, precision and recall. F1 score can be interpreted as a weighted average of the precision and recall values, where an F1 score reaches its best value at 1 and worst value at 0.

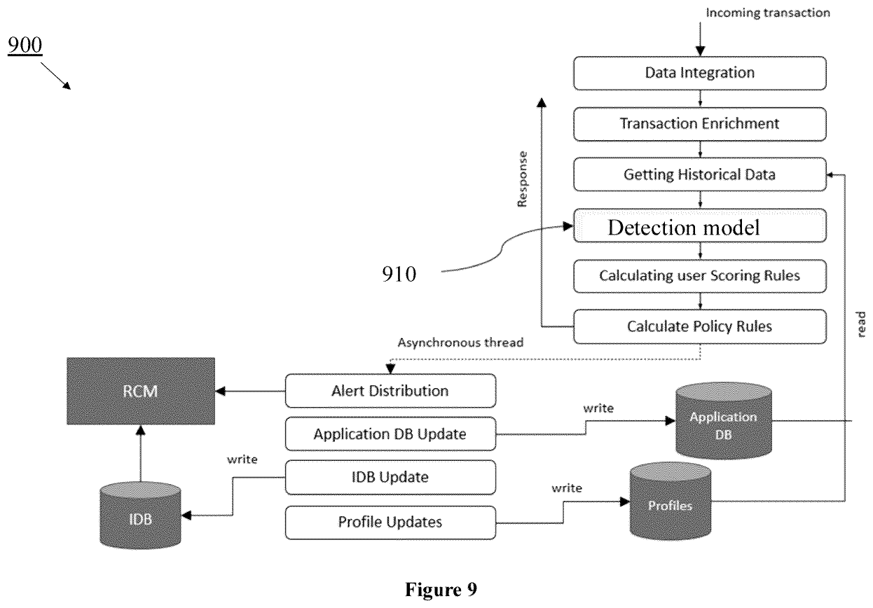

FIG. 9 is a high-level process flow diagram of a system 900, in accordance with some embodiments of the present disclosure.

According to some embodiments of the current disclosure, a fraud-detection ML model, such as training fraud-detection ML model 260a in FIG. 2 that is operating in a finance-system in production-environment, may be deployed in a detection model, such as detection model 910.

According to some embodiments of the current disclosure, system 900 includes incoming financial transactions into a data integration component which is operating an initial preprocess of the data. Transaction enrichments is the process where preprocess of the transactions happen. The process of getting historical data synchronizes with new incoming transactions. It is followed by the detection model 910 after which, each transaction gets its risk score for being fraud.

A policy calculation treats the transactions having a high-risk score i.e., suspicious scores and routes it accordingly. Profiles contain aggregated financial transactions according time period. Profile updates synchronize according to new created or incoming transactions. Customer Relationship Management (CRM) is a system where risk score management is operated: investigation, monitoring, sending alerts, or marking as no risk.

According to some embodiments of the current disclosure, Investigation Data Base (IDB) system is used when research transactional data and policy rules resulting for investigation purposes. It analyzes historical cases and alert data.

According to some embodiments of the current disclosure, analysts can define calculated variables using a comprehensive context, such as the current transaction, the history of the main entity associated with the transaction, the built-in models result etc. These variables can be used to create new indicative features. The variables can be exported to the detection log, stored in IDB and exposed to users in user analytics contexts.

According to some embodiments of the current disclosure, financial transactions that satisfy certain criteria may indicate occurrence of events that may be interesting for the analyst. The analyst can define events the system identifies and profiles when processing the transaction. This data can be used to create complementary indicative features (using the custom indicative features mechanism or SMO). For example, the analyst can define an event that says: amount>$100,000. The system profiles aggregations for all transactions that trigger this event, e.g., first time it happened for the transaction party etc.

According to some embodiments of the current disclosure, Structured Model Overlay (SMO) is a framework in which the analyst gets all outputs of built-in and custom analytics as input to be used to enhance the detection results with issues and set the risk score of the transaction.

According to some embodiments of the current disclosure, analytics logic is implemented in two phases, where only a subset of the transactions goes through the second phase, as determined by a filter. The filter may be a business activity.

According to some embodiments of the current disclosure, the detection log contains transactions enriched with analytics data such as indicative features results and variables. The Analyst has the ability to configure which data should be exported to the log and use it for both pre-production and post-production tuning.

According to some embodiments of the current disclosure, the detection flow for transactions consists of multiple steps, data fetch for detection, e.g., detection period sets and profile data for the entity, variable calculations, analytics models consisting of different indicative feature instances, and SMO.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

1. A computerized-method for generating high-quality synthetic fraud data based on tabular data of financial transaction to train a fraud-detection machine leaning model of tenants, in a multitenant environment, said computerized-method comprising:
(i) receiving by a processor tabular data of financial transactions having one or more columns of a first tenant that is having extreme class imbalance;
(ii) operating by the processor a fixing module to handle missing values in the received tabular data of financial transactions and yield cleaned tabular data;
(iii) forwarding by the processor the cleaned tabular data to a deep learning based synthetic data generation module to generate synthetic fraud data that is encrypted;
(iv) combining by the processor fraud transactions from the yielded cleaned tabular data and the generated synthetic fraud data to a training dataset and sending the training dataset to a machine learning model to differentiate between original fraud transactions and synthetic fraud transactions;
(v) evaluating by the processor performance of the machine learning model by checking the machine learning model predictions of a preconfigured number of fraud transactions;
(vi) when there is above a preconfigured threshold number of wrong predictions, aggregating by the processor misclassified data to be stored in a high-quality synthetic fraud database;
(vii) generating by the processor a balanced training dataset that is comprised of a preconfigured percent of synthetic fraud transactions from the high-quality synthetic fraud database and nonfraud transactions from the received tabular data of financial transactions;
(viii) providing by the processor the generated balanced training dataset to a fraud-detection machine learning model of the first tenant that is having extreme class imbalance for training thereof, thereby increasing precision and accuracy of fraud predictions of the fraud-detection machine learning model when the fraud-detection machine learning model is processing real time data; and
(ix) using the received tabular data of financial transactions of the first tenant and the high-quality synthetic fraud database for generating a balanced training dataset and training a fraud-detection machine learning model of a second tenant that is having extreme class imbalance.

2. The computerized-method of claim 1, wherein the fixing-module comprising:
(i) calculating a median statistic for each column of the one or more columns that is having a numeric value to fill each empty cell in the column with the calculated median statistics; and
(ii) calculating a mode statistic for each column of the one or more columns that is having a categorical value to fill each empty cell in the column with the calculated mode statistic.

3. The computerized-method of claim 1, wherein the deep learning based synthetic data generation module is Conditional Generative Adversarial Networks (CTGAN).

4. The computerized-method of claim 1, wherein the tabular data of financial transactions is having extreme imbalance between fraud and nonfraud transactions, and wherein the extreme imbalance is when fraud transactions are below 0.01% of total financial transactions.

5. The computerized-method of claim 1, wherein misclassified data is an indication of high-quality results.

6. The computerized-method of claim 1, wherein when there is above a preconfigured threshold number of wrong predictions, the synthetic fraud transactions are misclassified as original fraud transactions.

7. The computerized-method of claim 1, wherein misclassified data includes synthetic fraud transactions which were classified as original fraud transactions.

8. The computerized-method of claim 2, wherein the median statistic is calculated based on formula I:
$$median ( X ) = \{ \begin{matrix}X [ \frac{n}{2} ] if n is even \\ X [ \frac{n - 1}{2} ] + X [ \frac{n + 1}{2} ] if n is odd\end{matrix}$$
whereby:
n is number of values in a column in the tabular data of financial transactions, and
X is an ordered list of n values in the column.

9. The computerized-method of claim 2, wherein the mode statistic is calculated by counting occurrence of each category and determining the mode statistic as a category having highest count of occurrences.

10. (canceled)

11. The computerized-method of claim 1, wherein in a multitenant environment, for each one or more tenants, generating high-quality synthetic fraud data based on a received tabular data of financial transaction to be stored in the high-quality synthetic fraud database, wherein the high-quality synthetic fraud data is used to generate the balanced training dataset.

12. The computerized-method of claim 1, wherein the increasing precision and accuracy of fraud predictions of the fraud-detection machine learning model is measured by at least one of: (i) Receiver Characteristic Operator (ROC) Area under Curve (AUC); (ii) precision; (iii) recall; (iv) F1 score; and (v) another criterion.
